(19) United States
(12) Patent Application Publication
(10) Pub. No.: US 2025/0059721 A1
(43) Pub. Date: Feb. 20, 2025

(54) METHOD FOR INSTALLATION OF A TRANSITION PIECE ON A MONOPILE FOUNDATION

(71) Applicant: SEAWAY 7 ENGINEERING B.V., EE Zoetermeer (NL)

(72) Inventor: Jan DYSVIK, Snarøya (NO)

(21) Appl. No.: 18/719,216

(22) PCT Filed: Dec. 15, 2022
(86) PCT No.: PCT/EP2022/086209

§ 371 Date: Jun. 12, 2024

(30) Foreign Application Priority Data
Dec. 15, 2021 (NO) 20211510

(51) Int. Cl. E02B 17/00; E02D 27/42; E02D 27/52; F03D 13/10; F03D 13/25

(52) U.S. Cl. CPC E02B 17/0004; E02D 27/425; E02D 27/525; F03D 13/126; F03D 13/25; E02B 2017/0047; E02B 2017/0065; E02B 2017/0091; F05B 2230/61; F05B 2240/95

(57) ABSTRACT

A method for installation of a transition piece on a monopile foundation of an offshore wind turbine along a common axis extending in a longitudinal direction is performed from a floating installation vessel. Buffer elements are arranged around an inner circumference of the transition piece and/or the monopile structure. The transition piece is lifted and lowered onto the monopile structure by use of a crane, and landed onto the monopile structure through the use of the buffer elements. A number of hydraulic cylinder jacks for circumferential alignment of bolt holes are provided in the transition piece and monopile, and alignment tools are used for alignment of the flanges provided on each of the transition piece and the monopile. The transition piece is lifted and the buffer elements are removed after which the transition piece is lowered onto the monopile, and bolts are tensioned fix the transition piece to the monopile.

The present invention relates to a method for installation of a first tubular element on a second tubular element with a positioning device, and more particularly the present invention relates to a method for accurate alignment and mounting of a transition piece on a monopile foundation of an offshore wind turbine.

Today large scale structures, such as wind turbines and offshore wind turbines, are typically mounted on an assembly of a monopile and a transition piece. One end of the monopile is fixed into a ground onshore or a seabed offshore, and at an opposite end, i.e. an upper end of the monopile, the transition piece is mounted. The assembled construction of the monopile and the transition piece will provide a level platform for mounting the turbine itself.

The assembly of the transition piece and monopile carries a load of the wind turbine. It is therefore essential that the assembly of the transition piece and monopile is stable and that the transition piece does not move relative the monopile.

Conventionally the transition piece is fixed or stabilized relative to the monopile by grouting and/or bolting the two elements, i.e. the transition piece and the monopile, together. The monopile and the transition piece are cylindrical bodies that are concentrically arranged with an annular space in between, and the two bodies are then mounted and fixed together by a grout seal formed in the annular space between the monopile and the transition piece and/or by bolting the transition piece and monopile together.

However, the transition piece could be fixed or stabilized to the monopile in other ways, for instance by providing each of the transition piece and monopile with a flange, whereby the two elements are connected by a plurality of stud bolts passing through the flanges.

An alternative way is to provide either the transition piece or the monopile with a skirt fitted with seals for grout.

The above-mentioned installations are done from jack-ups, with limited movements of the transition piece once the transition piece is in an installation position, where the movements in the load, with a fixed position, are not a critical consideration.

The assembly will be subject to significant stresses, for instance vibrations from operation as well as movements from waves, wind, and tide, where this may induce movement of the monopile relative to the transition piece.

EP 2.910.686 B1 relates to a connection of a vertical tubular foundation pile to a superstructure by overlapping tapered pipes wherein that the contact area of the conical pipes is restricted to a contact area between an outer ring and an inner ring near the top of the overlapping length, with matching conical contact surfaces, and a contact area between an outer ring and an inner ring near the bottom of the overlapping length.

EP 3.064.309 A1 relates to a positioning device for accurate mutual alignment of a first and a second tubular element along a common axis extending in a longitudinal direction of the two elements for the purpose of coupling these elements. The positioning device comprises an engaging means with which the device can be rigidly connected to the first element; and a translation-rotation device which, in the situation where it is connected to the first element, is extendable in a radial direction of the first element to a position against an outer surface of the second element and can exert a radial and peripheral force thereon, whereby the elements are displaced in the radial direction or rotated relative to each other. Also described is a corresponding method. The device and method are particularly suitable for accurate mounting of a transition piece on a mono-pile foundation of an offshore wind turbine.

GB 2.475.305 A relates to a wind turbine installation, where the wind turbine installation comprises a tower and a support structure, e.g. a monopile. At least one resilient means is arranged such that it can support the weight of the tower on the support structure. The resilient means may be a disc or helical spring, a hydraulic spring or steel spring or an elastic pad of e.g. neoprene or nylon and may be pre-tensioned. The tower may be concentrically overlap mounted on the support with or without a transition member with the resilient means in between and the join may be principally supported by a cement based grout with the resilient means redundant in case of grout failure. The resilient element may be supported by a between pairs of brackets with resilient pads extending across lower bracket cut-outs to engage the top of the support and the bracket pairs may be spaced around the tower, e.g. six at 60 degree intervals.

WO 2013/057459 A1 relates to transition pieces for use with a monopile structure, a monopile structure having the aforementioned transition piece, use of a rigid spacer in a monopile structure, a method of installing the transition piece and a kit having a rigid spacer and an annular grout seal. The transition piece of the invention is for fixing to a cylindrical pile, and the transition piece comprises a cylindrical transition piece body and a plurality of rigid spacers projecting from an inner cylindrical wall of the transition piece body, each rigid spacer having a contact portion to abut against an outer wall of the pile, and the spacer being adjustably attached to the transition piece body so that the distance between the contact face and the inner wall of the transition piece body is adjustably fixed.

There is thus a need for alternatives to today's methods for installation of a transition piece on a monopile foundation on an offshore wind turbine.

An object of the present invention is to provide a method for installation of a transition piece on a monopile foundation on an offshore wind turbine which is simple and robust, and which may be used without danger of collapse under various conditions.

A further object of the present invention is to seek to solve one or more of the problems or drawbacks according to prior art.

Yet an object of the present invention is to take into consideration the movements of the load during the set-down operation.

These objects are achieved with a method for installation of a transition piece on a monopile foundation on an offshore wind turbine as defined in the independent claim 1. Advantageous embodiments of the present invention are indicated in the dependent claims.

### SUMMARY OF THE INVENTION

The present invention relates to a method for installation of a transition piece on a monopile foundation of an offshore wind turbine along a common axis extending in a longitudinal direction of the transition piece and the monopile foundation, the installation being done from a floating installation vessel, wherein the method comprises the following steps:
a) arranging a plurality of buffer elements around an inner circumference of the transition piece and/or the monopile structure,
b) lifting and lowering the transition piece towards the monopile by use of a crane,
c) landing the transition piece onto the monopile structure through the plurality of buffer elements,
d) using a number of hydraulic cylinder jacks for circumferential alignment of throughgoing holes provided in the transition piece and monopile foundation,
e) using alignment tools for alignment of the flanges provided on each of the transition piece and the monopile foundation
f) installing a plurality of flange guide pins through the aligned throughgoing holes and thereafter to lower bolts,
g) lifting up transition piece and removing the plurality of buffer elements,
h) lower the transition piece onto the monopile foundation, and
i) tensioning the bolts to fixate the transition piece to the monopile foundation.

According to one aspect, the method for installation of a transition piece on a monopile foundation of an offshore wind turbine may further include, after the step of lifting and lowering the transition piece onto the monopile by use of a crane, but before the step of landing the transition piece onto the plurality of buffer elements, to bring the transition piece into a first contact with the monopile through a plurality of primary guides provided on the monopile and/or monopile foundation for guiding the transition piece onto the monopile foundation.

The plurality of primary guides may be arranged around an outer circumference, around an inner circumference or around both an outer and inner circumference of the transition piece and/or monopile foundation.

According to one aspect, the method for installation of a transition piece on a monopile foundation of an offshore wind turbine may further include the step of bringing the transition piece into a second contact with the monopile through a plurality of secondary guides provided on the monopile and/or monopile foundation for guiding the transition piece into a correct position on the monopile foundation.

The plurality of secondary guides may be arranged around an outer circumference, around an inner circumference or around both an outer and inner circumference of the transition piece and/or monopile foundation.

The method for installation of a transition piece on a monopile foundation on an offshore wind turbine may further include the step of releasing the transition piece from the crane when the transition piece is landed onto the monopile.

According to one aspect, the method for installation of a transition piece on a monopile foundation of an offshore wind turbine may further include the step of installation of a number of horizontal jack pins around a circumference of the transition piece.

The method for installation of a transition piece an a monopile foundation on an offshore wind turbine may also include the step of installation of a plurality of threaded plugs in a flange provided around the circumference of the monopile foundation, where the threaded plugs are used to fixate vertical jacks to the monopile foundation.

Furthermore, the method for installation of a transition piece on a monopile foundation on an offshore wind turbine may also include the step of installation of flange guide pins and removing horizontal jack pins.

The method for installation of a transition piece on a monopile foundation on an offshore wind turbine may also include that step g) comprises lifting the transition piece by means of a plurality of jack-up cylinders arranged around the inner circumference of the transition piece, by:
Activating the jack-up cylinders and extending the jack pins of the jack-up cylinders through the throughgoing holes provided in the flange of the transition piece.
Preventing further extension of the jack-up cylinders by threaded bolts arranged below the jack-up cylinder wherein the threaded bolts form a support or abutment for the jack pins for lifting the transition piece.

### BRIEF DESCRIPTION OF THE FIGURES

Other advantages and characteristic features of the present invention will be seen clearly from the following detailed description, the appended figures and the following claims, wherein:

FIGS. 1A-1B illustrate a prior art wind turbine support structure, where FIG. 1A shows a side view of a general arrangement and the main parts of an offshore wind turbine, and FIG. 1B shows a slip joint before connection and after connection of a monopile and a transition piece,

FIG. 2A shows the installation of a transition piece on a monopile structure or monopile foundation from a floating vessel, and FIG. 2B shows in greater detail the transition piece and the monopile structure,

FIGS. 3A-3B show how a transition piece is landed on a monopile structure according to the present invention, where FIG. 3A shows the transition piece and the monopile structure from a side view and from above, while FIG. 3B shows an enlarged section between the transition piece and the monopile structure, where it can be seen that a buffer element is arranged between the two structures,

FIGS. 4A-4B show alignment methodology of the transition piece relative the monopile structure, where FIG. 4A shows a circumferential alignment, while FIG. 4B shows a radial alignment,

FIG. 5 shows how jack pins are installed around a circumference of the transition piece,

FIGS. 6A-6B show jack up and lowering of the transition piece relative the monopile structure, where FIG. 6A shows that the transition piece is jack up in order to remove the buffer elements, and FIG. 6B shows lowering of the transition piece when the buffer elements have been removed, and

FIG. 7 shows how the bolts are tensioned.

### DETAILED DESCRIPTION

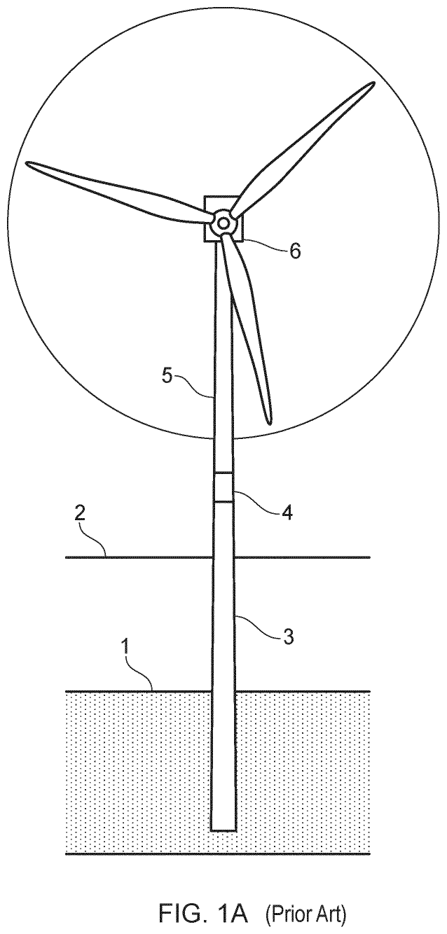

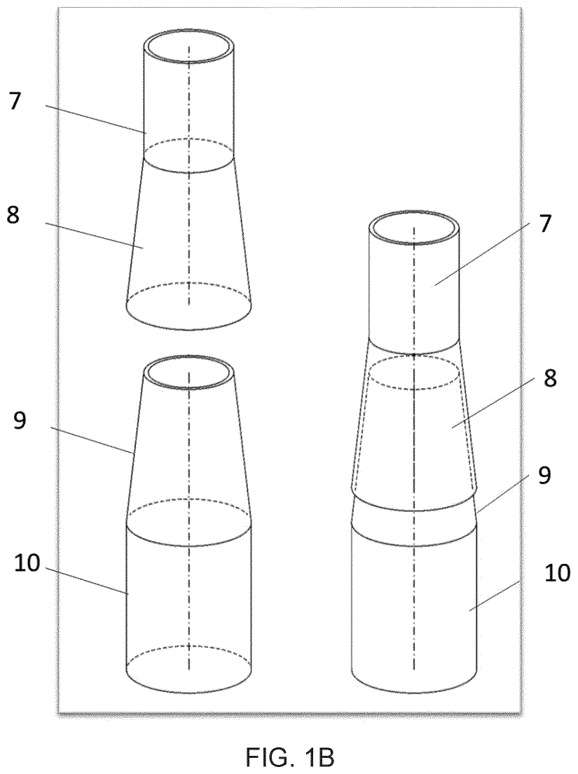

FIGS. 1A-1B show a general arrangement of an offshore wind turbine in a body of water 2. The offshore wind turbine comprises a foundation pile 3, a connection structure 4 and a wind turbine tower 5 comprising a turbine nacelle and rotor 6.

Through this prior art method for installation, the foundation pile 3 is driven into a seabed 1, whereafter the connection structure 4 is connected to the foundation pile 3. When the connection structure 4 in form of a slip joint is connected to the foundation pile 3, the wind turbine tower 5 is connected to the connection structure 4. Finally, the turbine nacelle and the rotor 6 are connected to the wind turbine tower 5.

The slip joint provides for a connection between the foundation pile 3 and the wind turbine tower 5.

FIG. 1B shows a bottom part 7 of the wind turbine tower 5, an upper conical part 8 of the slip joint 4, a lower conical part 9 of the slip joint 4 and an upper part 10 of the foundation pile 3.

The geometrical fit of the cones surfaces determines how mechanical loads from the turbine are transferred to the foundation pile 3.

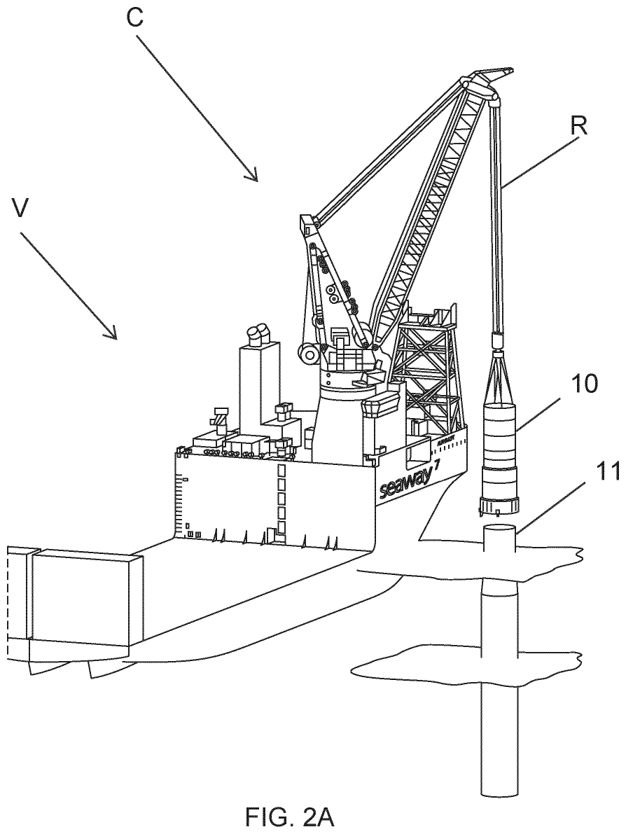

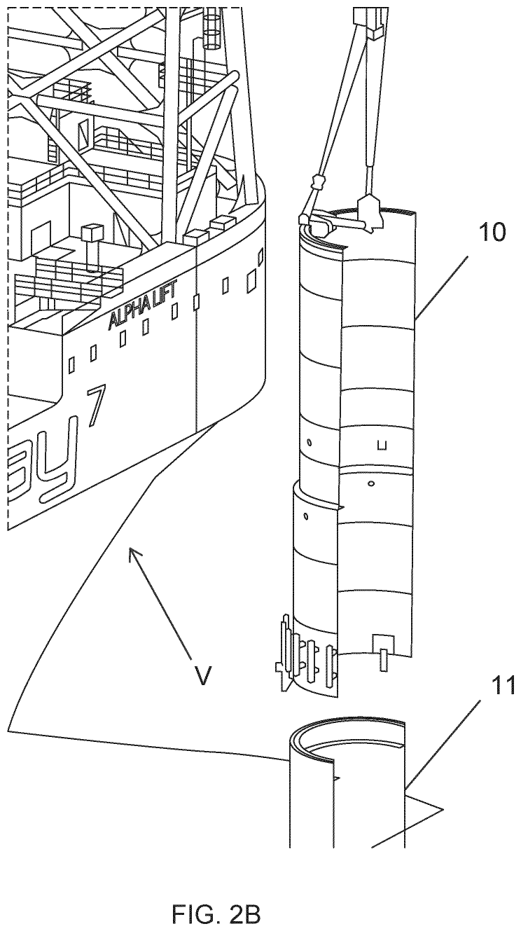

The present invention relates to a method for mounting of a transition piece 10 on a monopile structure 11 of an offshore wind turbine, where FIG. 2A shows that the transition piece 10 is lifted from a floating installation vessel V and onto the monopile structure 11 through use of a crane C.

The transition piece 10 is then connected to the crane C through a number of cables, ropes R or the like, whereafter the crane C is used to erect and lift the transition piece 10 from the floating installation vessel V. The crane C will lift the transition piece 10 over the monopile structure 11 and thereafter lower the transition piece 10 down and onto the monopile structure 11.

However, before the transition piece 10 is lifted and lowered onto the monopile structure 11, a plurality of buffer elements 12 are arranged around a circumference of the transition piece 10, where the buffer elements 12 are connected to a flange 14 provided on an inner side of the transition piece 10.

However, it should be understood that the plurality of buffer elements 12 also may be arranged and connected around a circumference of the monopile structure 11, where the buffer elements 12 then are connected to a flange 13 provided in an inner side of the monopile structure 11.

In one exemplary embodiment six buffer elements 12 are arranged around the inner circumference of transition piece 10, where the buffer elements 12 are arranged at a distance of 60 degrees from each other.

However, it should be understood that the number of buffer elements 12 may be larger or smaller, where the number of buffer elements 12 will depend on the size and/or weight of the transition piece 10, loads the monopile structure 11 and/or the transition piece 10 is/are subjected to during the assembly, what material the buffer elements 12 are made of etc.

When the transition piece 10 is lowered down onto the monopile structure 11 and brought into contact with the monopile structure 11, the transition piece 10 will “rest” onto the monopile structure 11 through the number of buffer elements 12.

The buffer elements 12 will reduce the impact loads onto the transition piece 10 and the monopile structure 11 during the lowering of the transition piece 10 towards the monopile structure 11 and will also provide substantially static conditions once the transition piece 10 is “landed” onto the monopile structure 11.

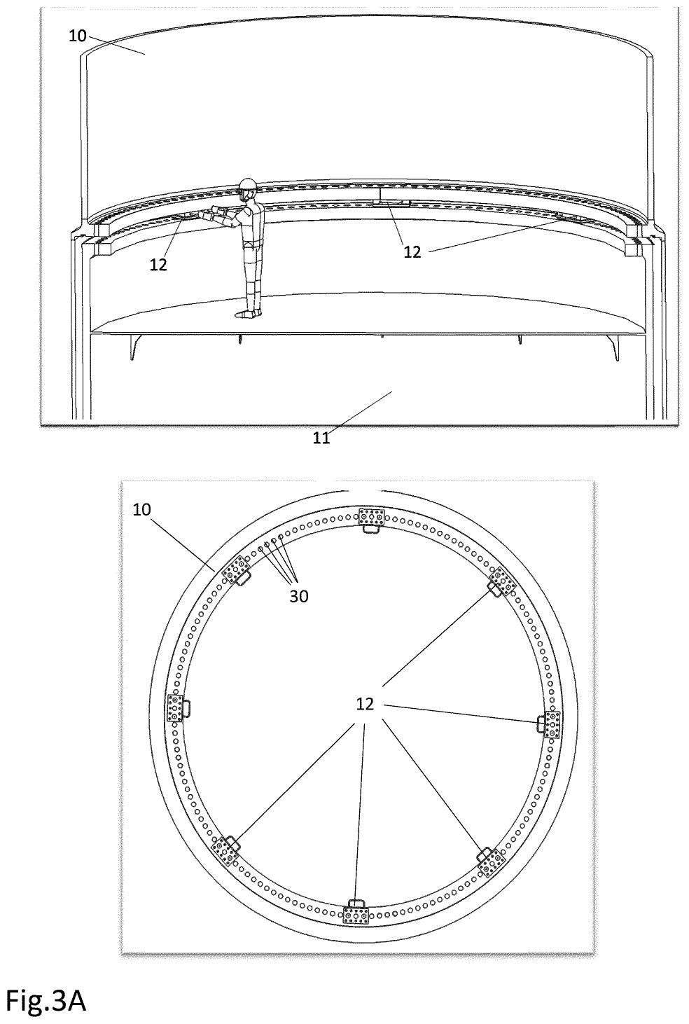

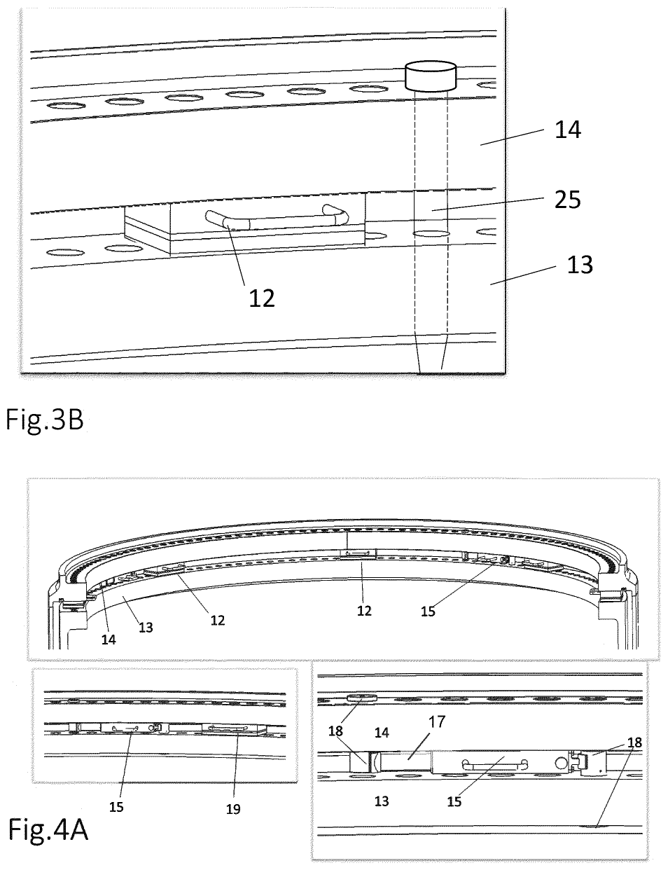

The buffer elements 12 may, for instance, be rubber elastomer bearings or the like. FIG. 3B shows in greater detail how the buffer element 12 (only one buffer element 12 is shown) is arranged on the inner flange 14 of the transition piece 10, where it also can be seen that the monopile structure 11 is provided with a flange 13 provided around an inner circumference of the monopile structure 11.

When the transition piece 10 is landed onto the monopile structure 11, the transition piece 10 and monopile structure 11 will rest against the buffer elements 12, through their respective flanges 13, 14.

Each of the flanges 13, 14 of the monopile structure 11 and the transition piece 10 is provided with a plurality of throughgoing holes 30, where the throughgoing holes 30, through bolts or the like, are used to connect and fix the transition piece 10 to the monopile structure 11. However, the throughgoing holes 30 of the flanges 13, 14 must be aligned with each other before bolts or the like may be installed through the throughgoing holes 30, where this alignment is done in a two-step process.

In a first step a plurality of hydraulic cylinder jacks 15 are arranged between the flanges 13, 14 of the monopile structure 11 and the transition piece 10, where these hydraulic cylinder jacks 15 will provide a circumferential alignment of the monopile structure 11 and the transition piece 10.

Each hydraulic cylinder jack 15 comprise a cylinder body 16, where a rod 17 extends out from one end of the cylinder body 16. A “fixation bolt” 18 is connected to each rod 17, where the “fixation bolts” 18 are arranged to extend out from the cylinder body 16 in opposite directions.

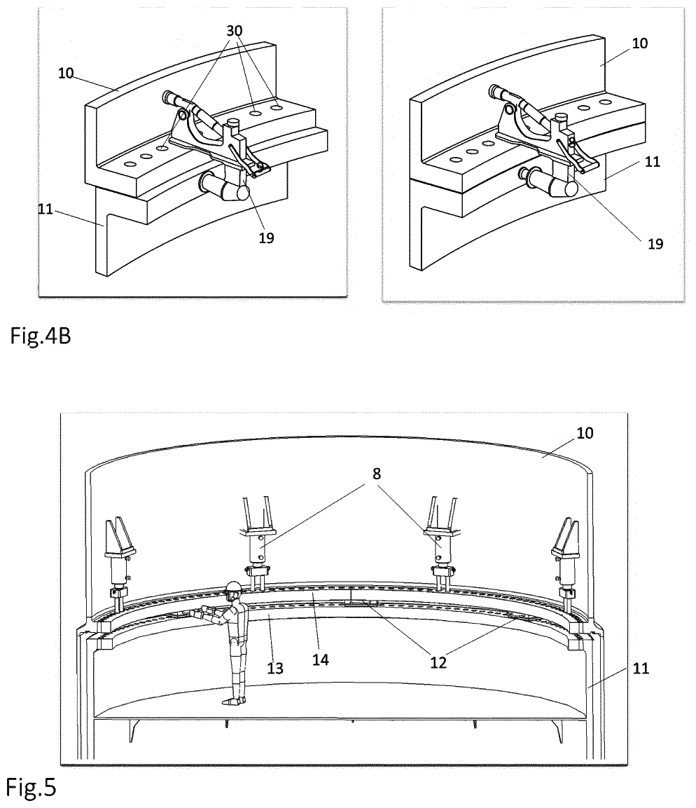

As can be seen from FIG. 4A, the hydraulic cylinder jacks 15 (only one hydraulic cylinder jack 15 is shown) are arranged in a space provided between the flanges 13, 14 of the monopile structure 11 and the transition piece 10, where one “fixation bolt” 18 is arranged in a throughgoing hole 30 provided in the flange 13 of the monopile structure 11 and one “fixation bolt” 18 is arranged in a throughgoing hole 30 provided in the flange 14 of the transition piece 10.

When the hydraulic cylinder jacks 15 are retracted (or extended), the transition piece 10 and monopile structure 11 will rotate relative each other. This rotation of transition piece 10 and the monopile structure 11 will align the throughgoing holes 30 provided in the flanges 13, 14 of the monopile structure 11 and the transition piece 10, such that bolts may be used to fasten the transition piece 10 to the monopile structure 11.

However, the flanges 13, 14 of the monopile structure 11 and the transition piece 10 may also be aligned in a radial direction, whereby a plurality of flange alignment tools 19 are arranged around the circumference of the flanges 13, 14.

Each flange alignment tool 19 comprises a “fixation bolt” and an adjustment mechanism.

The “fixation bolt” of the flange alignment tool 19 will be arranged in a throughgoing hole 30 provided in the flange 14 of the transition piece, while the adjustment mechanism will be arranged to be in contact with the flange 13 of the monopile structure 11.

When the flange alignment tool 19 is activated, the adjustment mechanism will be extended, such that the alignment tool 19 is pushed away from the flange 14 of the monopile structure 11. At the same time, as the “fixation bolt” is arranged in the throughgoing hole 30 of the flange 14 of the transition piece 10, the movement of the flange alignment tool 19 away from the flange 14 of the monopile structure 11 will pull or drag the flange 14 of the transition pile 10 such that a radial alignment of the throughgoing holes 30 provided in the flanges 13, 14 is obtained.

When the throughgoing holes 30 provided in the flanges 13, 14 of the monopile structure 11 and the transition piece 10 are aligned in both a circumferential and radial direction, the next step is to install a plurality of flange guide pins 25 in the aligned thoroughgoing holes 30 and thereafter to lower bolts 31 in a static controlled condition.

FIG. 5 shows how a plurality of jack-up cylinders 20 are arranged around the inner circumference of the transition piece 10, where the jack-up cylinders 20 in appropriate ways are connected to the transition piece 10.

Furthermore, a threaded bolt is arranged, in a throughgoing hole 30 provided in the flange 13 of the monopile structure 11, below the jack-up cylinder 20. The threaded bolt will then form a support or abutment for jack pins 26 of the jack-up cylinder 20.

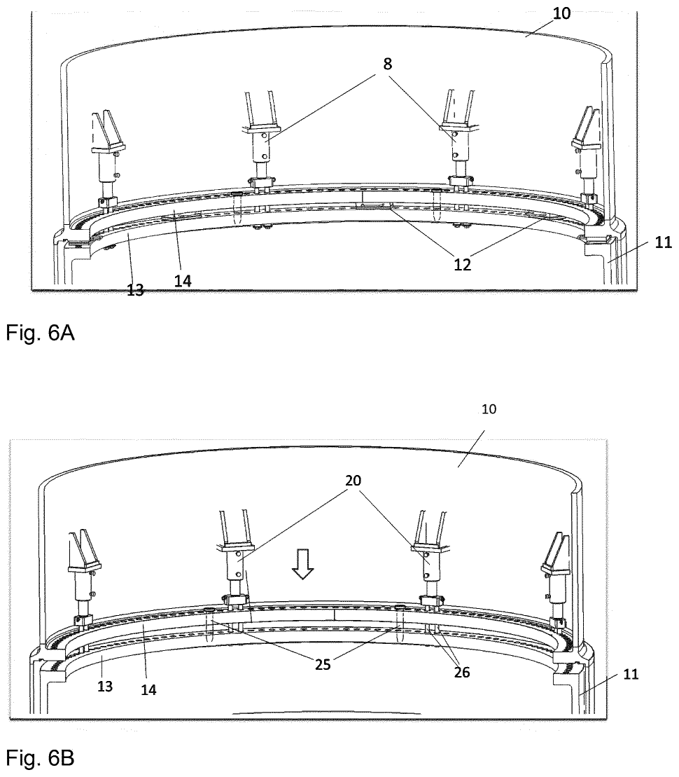

When the jack-up cylinders 20 are activated, jack pins 26 of the jack-up cylinders 20 will extend through the throughgoing holes 30 provided in the flange 14 of the transition piece 10 as seen in FIGS. 6A and B. The threaded bolts will then prevent a further extension of the jack-up cylinders 20, whereby this will result in that the transition piece 10 is lifted up and away from the monopile structure 11.

FIG. 6A shows that the transition piece 10 has been lifted up and away from the monopile structure 11, thereby providing a gap or space between the transition piece 10 and monopile structure 11, where this gap or space is enough to allow removal of the plurality of buffer elements 12 arranged around the circumference of the monopile structure 11 and/or the transition piece 10. Also shown are two flange guide pins 25. The purpose of the flange guide pins 25 is to take horizontal loads during removal of the buffer elements 12. Vertical loads are handled by the jack pins 26.

FIG. 6B shows that the buffer elements 12 have been removed, whereafter the hydraulic pressure in the jack-up cylinders 20 is released in order to lower the transition piece 10 into contact with the monopile structure 11 in a controlled manner.

Before the transition piece 10 is brought into contact with the monopile structure 11, bolts are arranged in the plurality of through-going holes 30 provided in each of the flanges 13, 14 of the monopile structure 11 and transition piece 10, whereafter the transition piece 10 is lowered down in order to be brought into contact with the monopile structure 11.

The bolts are thereafter tensioned in order to fixate the transition piece 10 to the monopile structure 11.

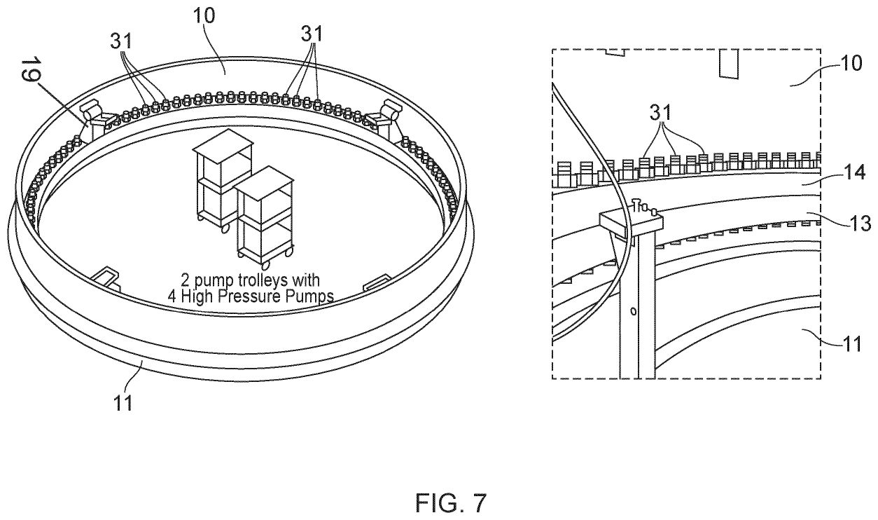

FIG. 7 shows how bolts 31 or the like are arranged in the plurality of throughgoing holes 30 in the flanges 13, 14 of the monopile structure 10 and the transition piece 10, whereafter the bolts 31 are tensioned in appropriate ways.

The invention has now been explained with several non-limiting exemplary embodiments. One skilled in the art will appreciate that a variety of variations and modifications can be made to the method for installation of a transition piece on a monopile foundation as described within the scope of the invention as defined in the appended claims.

1. A method for installation of a transition piece (10) on a monopile foundation (11) of an offshore wind turbine along a common axis extending in a longitudinal direction of the transition piece (10) and the monopile foundation (11), the installation being done from a floating installation vessel (V), characterized in that the method comprises the following steps:
a) arranging a plurality of buffer elements (12) around an inner circumference of the transition piece (10) and/or the monopile foundation (11);
b) lifting and lowering the transition piece (10) towards the monopile foundation (11) by use of a crane;
c) landing the transition piece (10) onto the monopile foundation (11) through the plurality of buffer elements (12);
d) using a number of hydraulic cylinder jacks (15) for circumferential alignment of throughgoing holes (30) provided in the transition piece (10) and monopile foundation (11);
e) using a plurality of alignment tools (19) for alignment of flanges (14, 13) provided on each of the transition piece (10) and the monopile foundation (11);
f) installing a plurality of flange guide pins (25) through the aligned throughgoing holes (30) and thereafter to lower bolts (31);
g) lifting up transition piece (10) and removing the plurality of buffer elements (12);
h) lower the transition piece (10) onto the monopile foundation (11); and
i) tensioning the bolts to fixate the transition piece (10) to the monopile foundation (11).

2. Method according to claim 1, characterized in that the method further comprises the step of, after step b) but before step c):
bringing the transition piece (10) into a first contact with the monopile foundation (11) through a plurality of primary guides for guiding the transition piece (10) onto the monopile foundation (11).

3. Method according to claim 2, characterized in that the method comprises the step of:
bringing the transition piece (10) into a second contact with the monopole foundation (11) through secondary guides for guiding the transition piece (10) into a correct position on the monopile foundation (11).

4. Method according to claim 1, characterized in that the method comprises the step of:
releasing the transition piece (10) from the crane when the transition piece (10) is landed on the monopile foundation (11).

5. Method according to claim 1, characterized in that the method comprises the step of:
installation of a number of horizontal jack pins (26) around a circumference of the transition piece.

6. Method according to claim 5, characterized in that the method comprises the step of:
installation of flange guide pins (25) and removing horizontal jack pins (26).

7. Method according to claim 5, characterized in that step g) comprises:
lifting the transition piece by means of a plurality of jack-up cylinders (20) arranged around the inner circumference of the transition piece (10); by
activating the jack-up cylinders (20) and extending the jack pins (26) of the jack-up cylinders (20) through the thoroughgoing holes (30) provided in the flange (14) of the transition piece (10);
preventing further extension of the jack-up cylinders (20) by threaded bolts arranged below the jack-up cylinder (20) wherein the threaded bolts form a support or abutment for the jack pins (26) for lifting the transition piece (10).
